(19) United States
(12) Patent Application Publication
(10) Pub. No.: US 2016/0247343 A1
(43) Pub. Date: Aug. 25, 2016

(54) METHOD FOR PAIRING AN ACTUATOR WITH AT LEAST ONE WIRELESS TRANSMITTER, METHOD FOR CONTROLLING SUCH AN ACTUATOR AND CLOSING INSTALLATION COMPRISING SUCH AN ACTUATOR

(71) Applicant: SIMU, Gray (FR)

(72) Inventor: Guillaume PAILLERET, TROMAREY (FR)

(21) Appl. No.: 15/041,245

(22) Filed: Feb. 11, 2016

(30) Foreign Application Priority Data
Feb. 23, 2015 (FR) 1551533

(51) Int. Cl. G07C 9/00; H04W 4/00

(52) U.S. Cl. CPC G07C 9/00896; H04W 4/008; G07C 2009/00928

(57) ABSTRACT

Method for pairing an actuator with at least one wireless transmitter within a closing installation including a receiver receiving signals transmitted by the transmitter, wherein the method includes steps of placing the transmitter at a determined distance from the receiver and sending, from the transmitter and to the receiver, an initial configuration signal; using the receiver, collecting an identifier of the transmitter contained in the configuration signal and determining the power of that signal; and comparing the determined power of the signal with a pre-established threshold value; if the determined power of the signal is above the pre-established threshold value, storing the identifier of the transmitter and the value of this power in a memory associated with the actuator; and if the determined power of the signal is lower than the pre-established threshold value, rejecting the transmitter as being incompatible with a desired operation of the installation.

### FIELD OF THE INVENTION

The present invention relates to a method for pairing an actuator with at least one wireless transmitter within a closing installation, for example comprising a garage door, a gate or a business gate. A closing installation generally comprises a receiver for receiving signals transmitted by one or more transmitters.

### BACKGROUND OF THE INVENTION

In the home automation field, it is known to use a closing installation to selectively close an entrance, path or garage. Some closing installations can be controlled remotely using a wireless transmitter, in particular a remote control. In order to avoid personal accidents, it is known to block the control of the actuator by the transmitter when the transmitter is beyond a predetermined distance, for example approximately ten meters. This function makes it possible to guarantee control within sight of the closing installation. It is sometimes described as a “dead man control mechanism”. However, dispersions exist in the control chain of the actuator. These dispersions come from allowances regarding the transmission power of the transmitter and the sensitivity of the receiver. These dispersions also come from the presence of obstacles to the transmission of the signals, such as trees or a wall. Control within sight of the closing installation is therefore not securely guaranteed.

One solution to limit the range of the transmitters is to adjust the sensitivity of the transmitter with a potentiometer. However, given that this solution applies to all of the transmitters, it is not possible to select a different range for each transmitter. Another solution consists of using a reduced range transmitter, without any possible adjustment. In this case, the range of the transmitter is predetermined and is not adjustable relative to the configuration of the closing installation. For example, a maximum selected range of ten meters is not appropriate for a garage door clearly visible from fifteen or twenty meters away. Conversely, this nominal range of ten meters is not appropriate for a configuration where the closing installation is only visible from five meters away, for example due to a turn.

Document DE-U-20 2014 102 241 discloses a control system for a garage door. The control system comprises a receiver suitable for receiving the signals transmitted by a transmitter. When a signal is sent from the transmitter to the receiver, the power of the control signal received by the receiver is compared with a threshold value saved in memory. If the power of the control signal received by the receiver is below this threshold value, the control of the actuator by the transmitter is blocked. It is not identified how this threshold value is determined. Thus, it is likely that this threshold value is the same for all garage doors. The threshold value is therefore not adjusted based on the visibility of the garage door, and there is a risk of the control of the garage door not being done within sight.

### SUMMARY OF THE INVENTION

The invention more particularly aims to remedy these drawbacks by proposing a method for pairing an actuator with at least one wireless transmitter, which makes it possible to guarantee control of the closing installation from within sight, under all circumstances.

To that end, the invention relates to a method for pairing an actuator with at least one wireless transmitter within a closing installation, this closing installation comprising a receiver receiving signals transmitted by the transmitter. The method comprises at least the following steps:
a) placing the transmitter at a determined distance from the receiver and sending an initial configuration signal from the transmitter and to the receiver,
b) using the receiver, collecting an identifier of the transmitter contained in the initial configuration signal and determining the power of that signal,
c) comparing the power of the signal determined in step b) with a pre-established threshold value,
d) if the power of the signal determined in step b) is above the pre-established threshold value, storing the identifier of the transmitter and the value of this power in a memory associated with the actuator, and
e) if the power of the signal determined in step b) is below the pre-established threshold value, rejecting the transmitter as being incompatible with the desired operation for the closing installation.

Owing to the invention, only transmitters capable of transmitting a control signal powerful enough to be received by the receiver at the determined distance are selected to be paired with the actuator of the closing installation. A maximum distance to activate the actuator using the transmitter can be set during the pairing, within a perimeter set by the pre-established threshold power value of the initial configuration signal. This maximum distance is chosen by the installer during pairing of the transmitter with the actuator, based on the visibility of the closing installation and/or other parameters, such as the frequency of use, the usage wish (for example, from a vehicle or by pedestrian), and the weather that day. These various parameters affect the available power at the transmitter during subsequent uses. The correspondence between the distance between the transmitter and the receiver and the power level of the initial configuration signal is also influenced by these various parameters. Thus, the maximum activation distance of an actuator of a concealed closing installation is chosen to be shorter than for a clear closing installation. Likewise, the maximum activation distance will be chosen to be larger if the user arrives in front of the door in a vehicle rather than on foot. The user equipped with the transmitter paired with the actuator cannot activate the actuator past the predetermined distance during pairing, which makes it possible to guarantee control of the closing installation from within sight. Furthermore, several transmitters can be paired separately and with a different maximum activation distance.

The rejection of the transmitter as being incompatible with a desired operation for the closing installation can simply mean that the installer must redo the pairing between this transmitter and the receiver at a distance closer to the receiver.

According to advantageous, but optional aspects of the invention, such a pairing may include one or more of the following features, considered in any technically allowable combination:
The distance used in step a) is defined as a function of the maximum desired distance, between transmitter and receiver, for the activation of the actuator by the transmitter.
The distance used in step a) is equal to the maximum desired distance between the transmitter and the receiver for activation of the actuator by the transmitter.
For a closing installation with several transmitters, the pairing method is implemented for each transmitter, with a determined distance selected in step a) for each transmitter.
In step a), all of the transmitters are placed at the same distance.
In step a), the transmitters are placed at different distances.

The invention also relates to a method for controlling an actuator of a closing installation paired with at least one transmitter according to a method as described above. This method comprises iterative steps consisting, during a control sequence of the closing installation, of:
f) collecting the identifier of the transmitter and the power of a control signal transmitted by the latter and received by the receiver,
g) verifying the authenticity of the identifier collected from the transmitter, and
h) comparing the power of the control signal received by the receiver with the power of the initial configuration signal saved in memory,
i) if the power of the control signal received by the receiver is lower than the power of the initial configuration signal, blocking the control of the actuator by the transmitter, and
j) if the power of the control signal received by the receiver is higher than the power of the initial configuration signal, allowing the control of the actuator by the transmitter.

According to one advantageous, but optional aspect of the control method, the identifier of the transmitter comprises a static code and a rolling code, while the static code is stored in the memory associated with the actuator and the rolling code is changed upon each step d) of the pairing method.

The invention also relates to a closing installation configured to carry out a method as previously described. The closing installation comprises an actuator, at least one transmitter, a receiver for receiving signals transmitted by each transmitter, means for collecting an identifier of each transmitter. The closing installation further comprises means for determining the power of an initial configuration signal, which is received by the receiver and which is transmitted by the transmitter at a determined distance from the receiver, and a memory for storing the identifier of the transmitter and the power of the received initial configuration signal, based on the result of the comparison of step c) of the pairing method.

According to one advantageous, but optional aspect of the closing installation, the latter further comprises means for verifying the authenticity of the collected identifier of the transmitter, and means for comparing the power of a control signal received by the receiver from the transmitter with the power of the initial configuration signal saved in memory for this transmitter.

### BRIEF DESCRIPTION OF THE DRAWINGS

The invention and other advantages thereof will appear more clearly in light of the following description of one embodiment of a pairing method according to its principle, provided solely as an example and done in reference to the appended drawings, in which:

FIG. 1 is a diagrammatic perspective view of a closing installation comprising an actuator, a transmitter and a receiver for receiving signals transmitted by the transmitter,

FIG. 2 is a diagram showing the different steps for carrying out a pairing method for pairing the actuator with the transmitter of FIG. 1, and

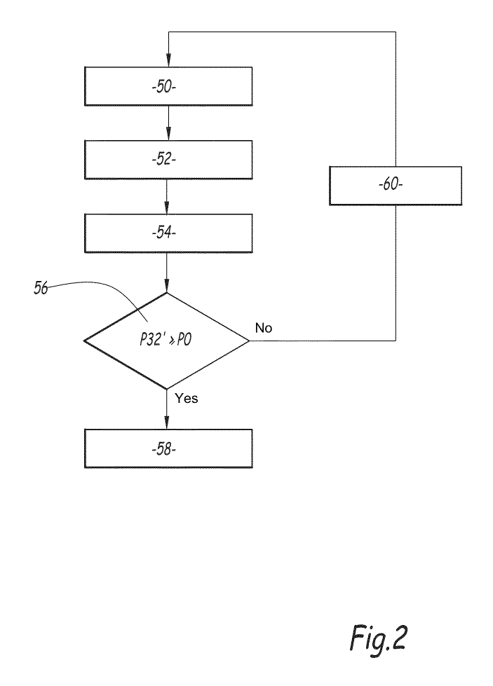

FIG. 3 is a diagram showing the different steps for carrying out a method for controlling the closing installation of FIG. 1.

### DETAILED DESCRIPTION OF THE INVENTION

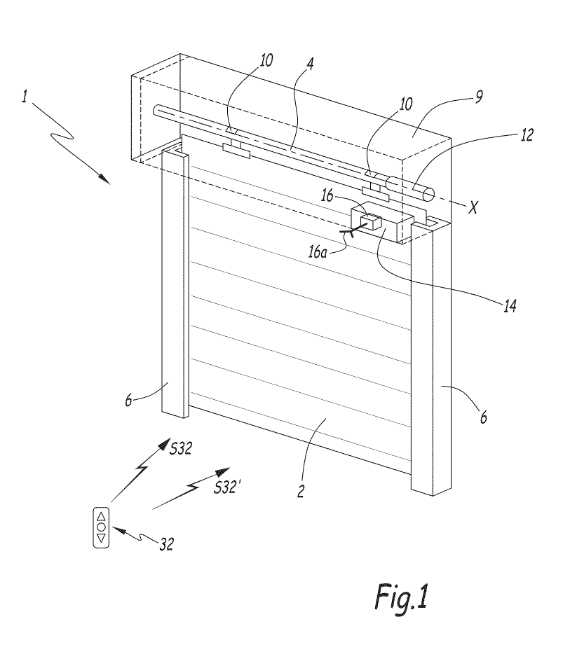

FIG. 1 shows a closing installation 1, which, in the example, is a garage door. This garage door comprises an apron 2, which is vertically movable and is guided in translation using two lateral slides 6. The closing installation 1 comprises a box 9 positioned in the upper part of the apron 2. The box 9 contains a tube 4 for winding the apron 2. The tube 4 is rotated around a horizontal axis X using an electric actuator 12. The apron 2 is attached to the tube 4 using hooks 10. The electric actuator 12 is controlled by a wireless transmitter 32, in the case at hand a remote control. The transmitter 32 is configured by the pairing method described below to be capable of transmitting a control signal S32 to a receiver 16 belonging to an electronic control unit 14, positioned inside the box 9 and configured to drive the actuator 12. The transmitter 32 communicates with the receiver 16 by radio channel, i.e., the receiver 16 includes an antenna 16a, diagrammatically shown in FIG. 1. The transmitter 32 can be a one-way radio transmitter, only capable of transmitting control orders, or a two-way radio transmitter, also capable of receiving signals.

A method is described below for pairing a new transmitter 32 with the actuator 12.

First, in one configuration mode, during step 50, the installer places the transmitter 32 at a determined distance from the receiver 16, and during step 52, sends an initial configuration signal S32′ from the transmitter 32 to the receiver 16. The position of the transmitter 32 for sending the initial configuration signal S32′ is chosen by the installer, in particular based on the visibility of the closing installation 1. Thus, the distance at which the initial configuration signal is sent must be smaller for a concealed closing installation 1 than for a clear closing installation 1. A concealed closing installation 1 for example corresponds to a garage door located at the end of a turn or behind trees, whereas a clear closing installation 1 for example corresponds to a garage door situated at the end of a straight alley. The position of the transmitter 32 during the pairing therefore depends on the visibility of the closing installation 1. It may also depend on other parameters, such as the usage frequency, the usage wish (for example, from a vehicle or by a pedestrian), the weather that day. These different parameters indeed affect the power available at the transmitter 32 during subsequent uses. The correspondence between the distance between the transmitter 32 and the receiver 16 and the power level P32′ of the initial configuration signal S32′ is also influenced by these different parameters.

The initial configuration signal S32′ is received by the receiver 16 in a step 54 and contains an identifier of the transmitter 32. The electronic control unit 14 collects this identifier and determines the power P32′ of the initial configuration signal S32′. This power is a radio power, sometimes described as RSSI (Received Signal Strength Indication) level or power.

The electronic control unit 14 next, during a step 56, compares the power of the initial configuration signal S32′ with a pre-established threshold value P0. This pre-established threshold value P0 depends on the sensitivity of the receiver 16, i.e., of the reception threshold of the receiver 16. This reception threshold corresponds to the minimum power that a signal must have to be able to be received by the receiver 16. The reception threshold defines the radio range between the transmitter 32 and the receiver 16 beyond which the initial configuration signal S32′ from the transmitter 32 is not received, or poorly received, by the receiver 16. The pre-established value P0 establishes a received power threshold at the receiver 16 equivalent to a reduced radio range relative to the radio range of the receiver 16. The pre-established value P0 is defined in the factory and corresponds to an activation distance for a standard installation and making it possible to meet the standards relative to the dead man control mechanism from a radio transmitter. In practice, this pre-established threshold value P0 is therefore increased relative to the reception power threshold of the receiver 16.

If the power P32′ of the initial configuration signal S32′ is above this pre-established threshold value P0, the identifier of the transmitter 32 and the power value P32′ of the initial configuration signal S32′ are stored, during a step 58, in the memory (not shown) associated with the electronic control unit 14, preferably integrated therein.

However, if the power P32′ of the initial configuration signal S32′ is below the pre-established threshold value P0, the transmitter 32 is rejected, in a step 60, because it is incompatible with a desired operation for the closing installation 1. The installer must therefore select a new, more powerful transmitter 32 to pair with the actuator 12, as shown by the return toward step 50.

The distance from the receiver 16 at which the transmitter 32 is placed to send the initial configuration signal S32′ in practice corresponds to the maximum desired distance, between the transmitter 32 and the receiver 16, for the activation of the actuator 12 by the transmitter 32.

According to one alternative that is not shown, the above pairing method can be repeated later to change the power value P32′ associated with a transmitter 32 whose identifier is already stored in memory. If the conditions of step d) are met, the new power value P32′ associated with the transmitter 32 is stored in place of the old value P32′.

In the event the determined power P32′ of the initial configuration signal S32′ in step b) is below the pre-established threshold value P0, the rejection of the transmitter 32 as being incompatible with a desired operation for the closing installation 1 can simply mean that the installer must redo the pairing between this transmitter 32 and the receiver 16 at a shorter distance from the receiver 16. Information specific to the receiver 16, for example a short actuation of the door, or the transmitter 32 if the latter is a two-way transmitter, can indicate this rejection to the installer.

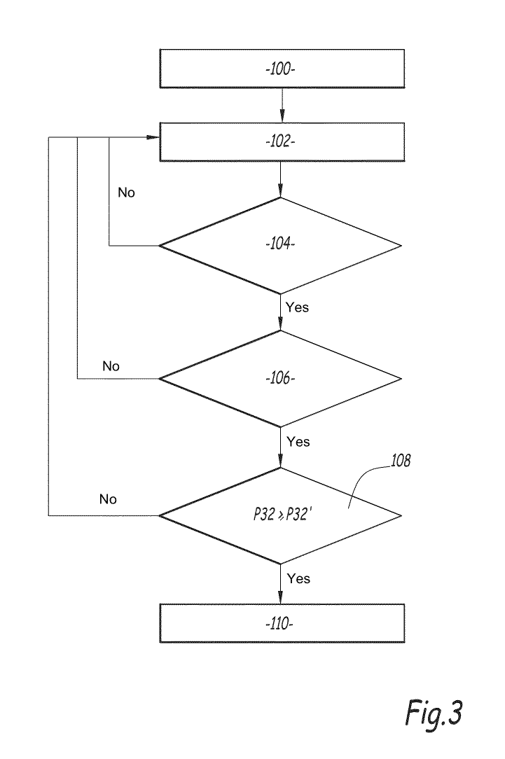

Below, in reference to FIG. 3, a method is described for controlling the actuator 12 paired with the transmitter 32 according to the method described above.

In FIG. 3, step 100 corresponds to starting up the receiver 16. When the user initiates a control sequence of the closing installation 1, he acts on the transmitter 32 to send a control signal S32 to the receiver 16. This control signal S32 is received by the receiver 16 during a step 102. In practice, the user must exert a continuous action on the transmitter 32 throughout the entire control sequence of the actuator 12, i.e., the user must keep an actuating button of the transmitter 32 pushed in to open or close the door 2 completely. The transmitter 32 then sends control signals S32 as long as the actuating button of the transmitter 32 is pushed in. If the user releases the button, the control of the actuator 12 by the transmitter 32 is blocked and the movement of the apron 2 is stopped. Thus, the transmitter sends successive control signals S32 to the receiver 16 throughout the entire control phase. The control method therefore comprises iterative steps 104 to 108 implemented each time a new signal is transmitted by the transmitter 32 and received by the receiver 16, i.e., the method is repeated each time a new control signal S32 is received by the receiver 16 in step 102.

In step 102, the receiver 16 collects the identifier of the transmitter 32, and the power P32 of the control signal S32 transmitted by the latter and received by the receiver 16 is determined. The authenticity of the collected identifier of the transmitter 32 is next verified in steps 104 and 106. The identifier of the transmitter 32 is a code comprising a static code and a rolling code. The static code is an address saved in the memory associated with the electronic control unit 14, while the rolling code is generated upon each new use of the transmitter 32. Step 104 consists of verifying that the address of the transmitter 32 is indeed saved in the memory associated with the actuator 12. If the address is saved, the control method continues. Step 106 consists of verifying that the rolling code is correct. The rolling code is generated using a code generator integrated into the transmitter 32. The same code generator is integrated into the electronic control unit 14 of the actuator 12. Thus, if the rolling codes respectively generated by the electronic control unit 14 and the transmitter 32 match, the rolling code sent by the transmitter 32 is correct and the control method continues.

If the address of the transmitter 32 is not saved in memory or if the static or rolling code sent by the transmitter 32 to the receiver 16 is incorrect, this means that the transmitter 32 used is not provided to work with the actuator 12, since it is not compared with the actuator 12 during the initial configuration. Thus, the control method stops and the control of the movement of the apron 2 by the actuator 12 is blocked. In practice, the control method stops at least until reception of the following control signal S32, as shown by the return arrows going from steps 104 and 106 to step 102 for receiving a new control signal S32.

A following step 108, implemented by the electronic control unit 14 of the actuator 12, consists of comparing the power P32 of the control signal S32 received by the receiver 16 with the power P32′ of the initial configuration signal S32′ saved in memory during the pairing. If, during the control method, the power P32 of the control signal S32 received by the receiver 16 is below the power P32′ of the initial configuration signal S32′, this means that the transmitter 32 is at a greater distance from the receiver 16 than the distance chosen by the installer during pairing, for example because the user is far away from the receiver 16, beyond the maximum saved distance. In this case, the control cannot be done with good visibility on the closing installation 1.

To avoid personal accident and therefore for security reasons, the control of the actuator 12 of the transmitter 32 is blocked, at least until reception of the following control signal S32, as shown by the return arrow between the comparison step 108 and the receiving step 102. The user must therefore remain close to the receiver 16 throughout the entire opening or closing sequence of the closing installation 1. This guarantees that the closing installation 1 is controlled from within sight. The user can then intervene in case of problem, for example if a person or object is below the apron 2 during closing. This therefore corresponds to a closing installation 1 with a “dead man control mechanism”.

Conversely, if the power P32 of the control signal S32 received by the receiver 16 is greater than or equal to the power P32′ of the initial configuration signal S32′, this means that the transmitter 32 is at a distance from the receiver 16 closer than that chosen by the installer during pairing. The control of the actuator 12 by the transmitter 32 is allowed and the movement of the apron 2 is controlled by the actuator 12, during step 110, at least until reception of a new control signal S32.

In an alternative that is not shown, the closing installation 1 is an electric gate, a barrier or a commercial gate.

According to another alternative that is not shown, the same pairing method can be used for a closing installation 1 with several transmitters 32. In this case, a pairing method is carried out separately for each transmitter 32, with a determined distance that can be equal or different for all of the transmitters 32.

According to another alternative that is not shown, the transmitter 32 automatically sends successive control signals S32 to the receiver 16 throughout the entire control phase, such that the user is not required to press continuously on a button of the transmitter 32, in particular of the remote control. The control method therefore comprises iterative steps 104 to 108 implemented each time a new signal is transmitted by the transmitter 32 and received by the receiver 16, i.e., the method is repeated each time a new control signal S32 is received by the receiver 16 in step 102.

According to another alternative that is not shown, the electronic control unit 14 is capable of detecting when the batteries of the transmitter 32 are changed, in particular by the modification of a part of the frame of the control signal S32 transmitted by the transmitter 32, so as to specify the status of the batteries. Indeed, the power P32 of the signal transmitted by the transmitter 32 is greater when the batteries are new than when they are used. Thus, if the receiver 16 receives a control signal S32 in which the part of the frame associated with the state of the batteries is replaced by a higher value, the electronic unit 14 deduces from this that the batteries have been changed and increases the power P32′ of the initial configuration signal S32′ saved in memory during pairing. This thus involves automatically adjusting the power value P32′ of the initial configuration signal S32′. For example, the power of the initial configuration signal S32′ can be increased by 20% or 50% or mathematically by using the information relative to the state of the batteries contained in the frame. This makes it possible to prevent a user having a transmitter 32 with new batteries from being able to control the actuator 12 using the transmitter 32 beyond the distance provided by the installer. The automatic adjustment also makes it possible to offset a deterioration of the condition of the batteries. However, the power P32′ of the initial configuration signal S32′ cannot be decreased below the pre-established threshold value P0.

According to another alternative that is not shown, the distance from the receiver 16 at which the transmitter 32 is placed to send the initial configuration signal S32′ does not correspond to the desired maximum distance between the transmitter 32 and the receiver 16 for the activation of the actuator 12 by the transmitter 32, but to a smaller distance. The desired maximum distance can thus, for greater security, be decreased to define the distance at which the initial configuration signal S32′ is sent and the distance at which the control signals will need to be transmitted later.

According to another alternative that is not shown, the pairing method comprises a reiteration of step a) for positioning the transmitter 32 at a determined distance from the receiver 16 and sending the initial configuration signal S32′, step b) for collecting a transmitter identifier 32 contained in an initial configuration signal S32′ and determining the power P32′ of the signal S32′, and step c) for comparing the determined power P32′ of the initial configuration system S32′ with the pre-established threshold value P0, before making it possible to store the identifier of the transmitter 32 and a mean value of the associated powers P32′ received by the receiver 16. This reiteration can be implemented through pressing on the transmitter 32 twice, making it possible to send two consecutive initial configuration signals S32′, for example from two different positions with respect to the door to be controlled. This makes it possible to secure the learning of the power value P32′ of the initial configuration signal S32′.

The features of the alternatives and embodiments considered above may be combined with one another to create new embodiments of the invention.

1. A method for pairing an actuator with at least one wireless transmitter within a closing installation, this closing installation comprising a receiver receiving signals transmitted by the wireless transmitter, the method comprising at least the following steps:
a) placing the wireless transmitter at a determined distance from the receiver and sending an initial configuration signal from the wireless transmitter and to the receiver,
b) using the receiver, collecting an identifier of the wireless transmitter contained in the initial configuration signal and determining a power of the initial configuration signal,
c) comparing the power of the initial configuration signal determined in step b) with a pre-established threshold value,
d) if the power of the initial configuration signal determined in step b) is above the pre-established threshold value, storing the identifier of the wireless transmitter and the value of this power in a memory associated with the actuator, and
e) if the power of the initial configuration signal determined in step b) is below the pre-established threshold value, rejecting the wireless transmitter as being incompatible with the desired operation for the closing installation.

2. The pairing method according to claim 1, wherein the determined distance used in step a) is defined as a function of a maximum desired distance, between wireless transmitter and receiver, for the activation of the actuator by the wireless transmitter.

3. The pairing method according to claim 2, wherein the distance used in step a) is equal to the maximum desired distance between the wireless transmitter and the receiver for activation of the actuator by the wireless transmitter.

4. A method for pairing an installation with several wireless transmitters, for which a pairing method according to claim 1 is implemented for each wireless transmitter, with a determined distance selected in step a) for each wireless transmitter.

5. The pairing method according to claim 4, wherein, in step a), all of the wireless transmitters are placed at the same determined distance.

6. The pairing method according to claim 4, wherein, in step a), the wireless transmitters are placed at different determined distances.

7. A method for controlling an actuator of a closing installation paired with at least one wireless transmitter according to a method of claim 1, the method comprising iterative steps consisting, during a control sequence of the closing installation, of:
f) collecting the identifier of the wireless transmitter and a power of a control signal transmitted by the wireless transmitter and received by the receiver,
g) verifying the authenticity of the identifier collected from the wireless transmitter, and
h) comparing the power of the control signal received by the receiver with the power of the initial configuration signal saved in memory, and
i) if the power of the control signal received by the receiver is lower than the power of the initial configuration signal, blocking the control of the actuator by the wireless transmitter, and
j) if the power of the control signal received by the receiver is higher than the power of the initial configuration signal, allowing the control of the actuator by the wireless transmitter.

8. The control method according to claim 7, wherein the identifier of the wireless transmitter comprises a static code and a rolling code, wherein the static code is stored in the memory associated with the actuator and wherein the rolling code is changed upon each step d).

9. A closing installation configured to carry out a method according to claim 1, comprising:
an actuator;
at least one wireless transmitter,
a receiver for receiving signals transmitted by each wireless transmitter,
means for collecting an identifier of each wireless transmitter,
means for determining a power of an initial configuration signal, which is received by the receiver and which is transmitted by the wireless transmitter at a determined distance from the receiver, and
a memory for storing the identifier of the wireless transmitter and the power of the received initial configuration signal, based on the result of the comparison of step c).

10. The closing installation according to claim 9, wherein the closing installation further comprises:
means for verifying the authenticity of the identifier collected from the wireless transmitter, and
means for comparing a power of a control signal received by the receiver from the wireless transmitter with the power of the initial configuration signal saved in memory for said wireless transmitter.
